(19) United States
(12) Patent Application Publication
(10) Pub. No.: US 2025/0265053 A1
(43) Pub. Date: Aug. 21, 2025

(54) Section-Based Iterative Feedback to Different Levels of Compiler

(71) Applicant: SambaNova Systems, Inc., Palo Alto, CA (US)

(72) Inventors: Feng SHENG, Palo Alto, CA (US); Kin Hing LEUNG, Cupertino, CA (US)

(73) Assignee: SambaNova Systems, Inc., Palo Alto, CA (US)

(21) Appl. No.: 19/054,822

(22) Filed: Feb. 15, 2025

Related U.S. Application Data
(60) Provisional application No. 63/554,134, filed on Feb. 15, 2024.

(51) Int. Cl. G06F 8/41

(52) U.S. Cl. CPC G06F 8/41

(57) ABSTRACT

Systems and methods are disclosed for transforming a high-level program of a computing task into configuration data executable by a reconfigurable dataflow processor (RDP) including one or more arrays of configurable units where the compiler may include a first, second and third compiler levels. The third compiler level may receive a first intermediate representation (IR) of the high-level program generated by the second compiler level where the first IR is based on a second IR generated by the first compiler level. The third compiler level may determine a failure occurred during generating of the configuration data based on the first IR, determine, based on the failure and error handling data for the failure, whether to return compilation operations to one of the first compiler level or the second compiler level and return the compilation operations to the determined one of the first compiler level and the second compiler level.

This application claims the benefit of (priority to) U.S. Provisional Application 63/554,134 filed on Feb. 15, 2024, entitled “Section-based iterative feedback to different software stacks” (Attorney Docket No. SBNV1132USP01).

### RELATED APPLICATIONS AND DOCUMENTS

This application is related to the following papers and commonly owned applications:
Prabhakar et al., “Plasticine: A Reconfigurable Architecture for Parallel Patterns,” ISCA '17, Jun. 24-28, 2017, Toronto, ON, Canada;
Koeplinger et al., “Spatial: A Language and Compiler for Application Accelerators,” Proceedings of the 39th ACM SIGPLAN Conference on Programming Language Design and Embodiment (PLDI), Proceedings of the 43rd International Symposium on Computer Architecture, 2018;
Zhang et al., “SARA: Scaling a Reconfigurable Dataflow Accelerator,” 2021 ACM/IEEE 48th Annual International Symposium on Computer Architecture (ISCA), 2021, pp. 1041-1054;
U.S. Nonprovisional patent application Ser. No. 16/260,548, filed Jan. 29, 2019, entitled “MATRIX NORMAL/TRANSPOSE READ AND A RECONFIGURABLE DATA PROCESSOR INCLUDING SAME,” (Attorney Docket No. SBNV 1005-1);
U.S. Nonprovisional patent application Ser. No. 15/930,381, filed May 12, 2020, entitled “COMPUTATIONALLY EFFICIENT GENERAL MATRIX-MATRIX MULTIPLICATION (GEMM),” (Attorney Docket No. SBNV 1019-1);
U.S. Nonprovisional patent application Ser. No. 16/890,841, filed Jun. 2, 2020, entitled “ANTI-CONGESTION FLOW CONTROL FOR RECONFIGURABLE PROCESSORS,” (Attorney Docket No. SBNV 1021-1);
U.S. Nonprovisional patent application Ser. No. 17/023,015, filed Sep. 16, 2020, entitled “COMPILE TIME LOGIC FOR DETECTING STREAMING COMPATIBLE AND BROADCAST COMPATIBLE DATA ACCESS PATTERNS,” (Attorney Docket No. SBNV 1022-1);
U.S. Nonprovisional patent application Ser. No. 17/031,679, filed Sep. 24, 2020, entitled “SYSTEMS AND METHODS FOR MEMORY LAYOUT DETERMINATION AND CONFLICT RESOLUTION,” (Attorney Docket No. SBNV 1023-1);
U.S. Nonprovisional patent application Ser. No. 17/216,647, filed Mar. 29, 2021, entitled “TENSOR PARTITIONING AND PARTITION ACCESS ORDER,” (Attorney Docket No. SBNV 1031-1);
U.S. Provisional Patent Application No. 63/190,749, filed May 19, 2021, entitled “FLOATING POINT MULTIPLY-ADD, ACCUMULATE UNIT WITH CARRY-SAVE ACCUMULATOR,” (Attorney Docket No. SBNV 1037-6);
U.S. Provisional Patent Application No. 63/174,460, filed Apr. 13, 2021, entitled “EXCEPTION PROCESSING IN CARRY-SAVE ACCUMULATION UNIT FOR MACHINE LEARNING,” (Attorney Docket No. SBNV 1037-7);
U.S. Nonprovisional patent application Ser. No. 17/397,241, filed Aug. 9, 2021, entitled “FLOATING POINT MULTIPLY-ADD, ACCUMULATE UNIT WITH CARRY-SAVE ACCUMULATOR,” (Attorney Docket No. SBNV 1037-9);
U.S. Nonprovisional patent application Ser. No. 17/520,290, filed Nov. 5, 2021, entitled “SPARSE MATRIX MULTIPLIER IN HARDWARE AND A RECONFIGURABLE DATA PROCESSOR INCLUDING SAME,” (Attorney Docket No. SBNV 1046-2);

All of the related application(s) and documents listed above are hereby incorporated by reference herein for all purposes.

### BACKGROUND

The present subject matter relates to compiling computing tasks for course-grained reconfigurable (CGR) processors.

Reconfigurable processors can be configured to implement a variety of functions more efficiently or faster than might be achieved using a general-purpose processor executing a computer program. For example, coarse-grain reconfigurable architectures (e.g., CGRAs) are being developed in which the configurable units in the array are more complex than used in typical, more fine-grained FPGAs, and may enable faster or more efficient (e.g., dataflow) execution of various classes of functions. For example, CGRAs have been proposed that can enable implementation of energy-efficient accelerators for machine learning and artificial intelligence workloads. See, Prabhakar, et al., “Plasticine: A Reconfigurable Architecture for Parallel Patterns,” ISCA '17, Jun. 24-28, 2017, Toronto, ON, Canada.

Despite the promise of CGRAs, compiling the compute graphs for the configurable units of a CRGA remains a challenge.

### SUMMARY OF THE INVENTION

A system comprising a compiler configured to conduct a method of transforming a high-level program of a computing task into configuration data executable by a reconfigurable dataflow processor (RDP) including one or more arrays of configurable units, the compiler including at least a first compiler level of the compiler and a second compiler level of the compiler. The second compiler level may receive a first intermediate representation of the high-level program generated by the first compiler level or that is based on another intermediate representation generated by the first compiler level. The second compiler level may determine a failure occurred during a generating of a first representation of the high-level program based on the first intermediate representation where the first representation of the high level program may be one of a second intermediate representation of the high level program or the configuration data. The second compiler level may generate error handling data for use by the first compiler level. The first compiler level may then generate, based on the error handling data, a third intermediate representation of the high-level program. The second compiler level may then generate, based on one of the third intermediate representation or a fourth intermediate representation generated based on the third intermediate representation, a second representation of the high-level program, the second representation of the high level program being one of a fifth intermediate representation of the high level program or the configuration data.

A system or method that transforms a high-level program of a computing task into configuration data executable by a reconfigurable dataflow processor (RDP) including one or more arrays of configurable units, the compiler including at least a first compiler level of the compiler, a second compiler level of the compiler and a third compiler level of the compiler. The third compiler level may receive a first intermediate representation of the high-level program generated by the second compiler level, the first intermediate representation being based on a second intermediate representation generated by the first compiler level. The third compiler level may determine, a failure occurred during a generating of the configuration data of the high-level program based on the first intermediate representation. The third compiler level may generate error handling data for the failure for use by the first compiler level or the second compiler level and determine, based on the failure and the error handling data, whether to return compilation operations to one of the first compiler level or the second compiler level. The compilation operations may then return to the determined one of the first compiler level and the second compiler level.

### BRIEF DESCRIPTION OF THE DRAWINGS

FIG. 1 illustrates an example system including a coarse-grained reconfigurable (CGR) processor, a host, and a memory.

FIG. 2 illustrates an example of a computer, including an input device, a processor, a storage device, and an output device.

FIG. 3 illustrates example details of a CGR architecture including a top-level network (TLN) and two CGR arrays.

FIG. 4 illustrates an example CGR array, including an array of configurable nodes in an array-level network (ALN).

FIG. 5 illustrates an example of a pattern memory unit (PMU) and a pattern compute unit (PCU), which may be combined in a fused-control memory unit (FCMU).

FIG. 6 is a block diagram of a compiler stack implementation suitable for generating a configuration file for a CGR processor.

FIGS. 7A-7E illustrate various representations of an example user program corresponding to various stages of a compiler stack such as the compiler stack of FIG. 6.

FIG. 8 is a flowchart of one example of a compute graph compilation for a CGR dataflow computing system.

FIG. 9 is a flowchart of one example of a compute graph compilation for a CGR dataflow computing system.

FIG. 10 shows a flowchart of one example of a compute graph compilation for a CGR dataflow computing system.

FIG. 11 shows a flowchart of one example of a compute graph compilation for a CGR dataflow computing system.

FIG. 12 is a diagram of a compiler with dataflow for executing the compute graph compilation for a CGR dataflow computing system corresponding to the systems and techniques disclosed herein.

### DETAILED DESCRIPTION

The following detailed description is made with reference to the figures. Example implementations are described to illustrate the technology disclosed, not to limit its scope, which is defined by the claims. Those of ordinary skill in the art will recognize a variety of equivalent variations on the description that follows.

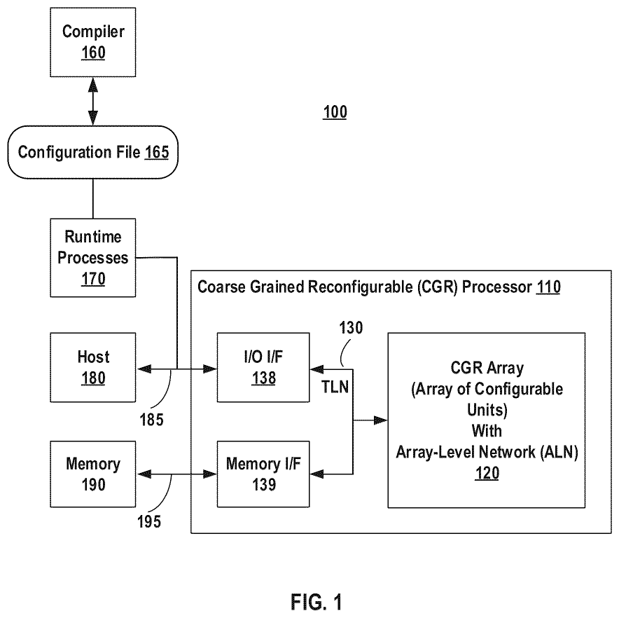

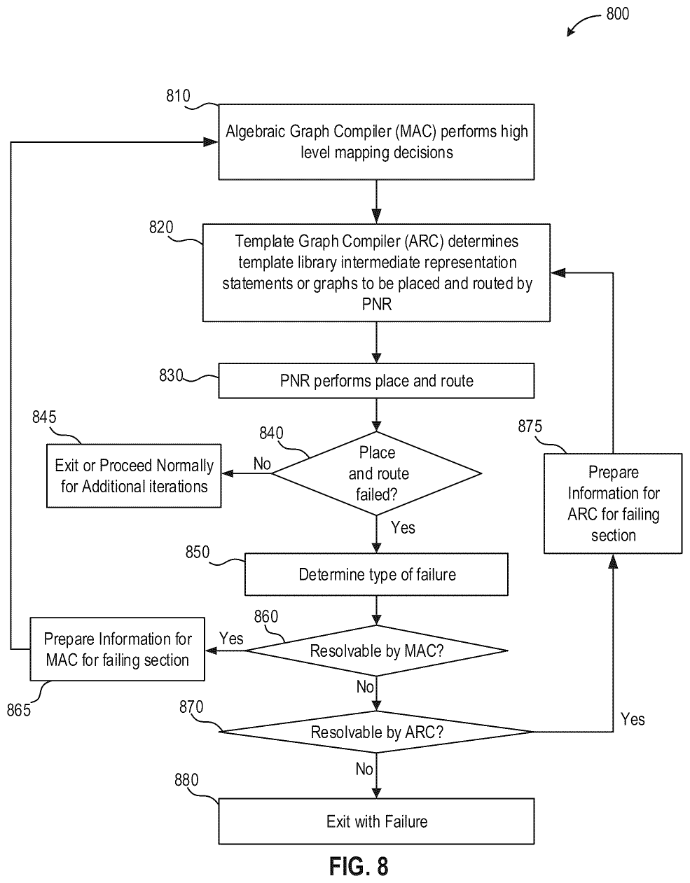

FIGS. 1-7E depict at least one example of an environment wherein the disclosed technology may be deployed while FIGS. 8-16 depict details on various examples of the disclosed technology.

Traditional compilers translate human-readable computer source code into machine code that can be executed on a Von Neumann computer architecture. In this architecture, a processor serially executes instructions in one or more threads of software code. The architecture is static, and the compiler does not determine how execution of the instructions is pipelined, or which processor or memory takes care of which thread. Thread execution is asynchronous, and safe exchange of data between parallel threads is not supported.

High-level programs for machine learning (ML) and artificial intelligence (AI) may require massively parallel computations, where many parallel and interdependent threads (meta-pipelines) exchange data. Such programs are ill-suited for execution on Von Neumann computers. They require architectures that are optimized for parallel processing, such as coarse-grained reconfigurable (CGR) architectures (CGRAs) or graphic processing units (GPUs). The ascent of ML, AI, and massively parallel architectures places new requirements on compilers, including how computation graphs, and in particular dataflow graphs, are pipelined, which operations are assigned to which compute units, how data is routed between various compute units and memory, and how synchronization is controlled particularly when a dataflow graph includes one or more nested loops, whose execution time varies dependent on the data being processed.

### Terminology

As used herein, the phrase one of should be interpreted to mean exactly one of the listed items. For example, the phrase “one of A, B, and C” should be interpreted to mean any of: only A, only B, or only C.

As used herein, the phrases at least one of and one or more of should be interpreted to mean one or more items. For example, the phrase “at least one of A, B, and C” or the phrase “at least one of A, B, or C” should be interpreted to mean any combination of A, B, and/or C. The phrase “at least one of A, B, and C” means at least one of A and at least one of B and at least one of C.

Unless otherwise specified, the use of ordinal adjectives first, second, third, etc., to describe an object, merely refers to different instances or classes of the object and does not imply any ranking or sequence.

The following terms or acronyms used herein are defined at least in part as follows:

AGCU—address generator (AG) and coalescing unit (CU).

AI—artificial intelligence.

AIR—arithmetic or algebraic intermediate representation.

ALN—array-level network.

Buffer—an intermediate storage of data.

CGR—coarse-grained reconfigurable. A property of, for example, a system, a processor, an architecture (see CGRA), an array, or a unit in an array. This property distinguishes the system, etc., from field-programmable gate arrays (FPGAs), which can implement digital circuits at the gate level and are therefore fine-grained configurable.

CGRA—coarse-grained reconfigurable architecture. A data processor architecture that includes one or more arrays (CGR arrays) of CGR units.

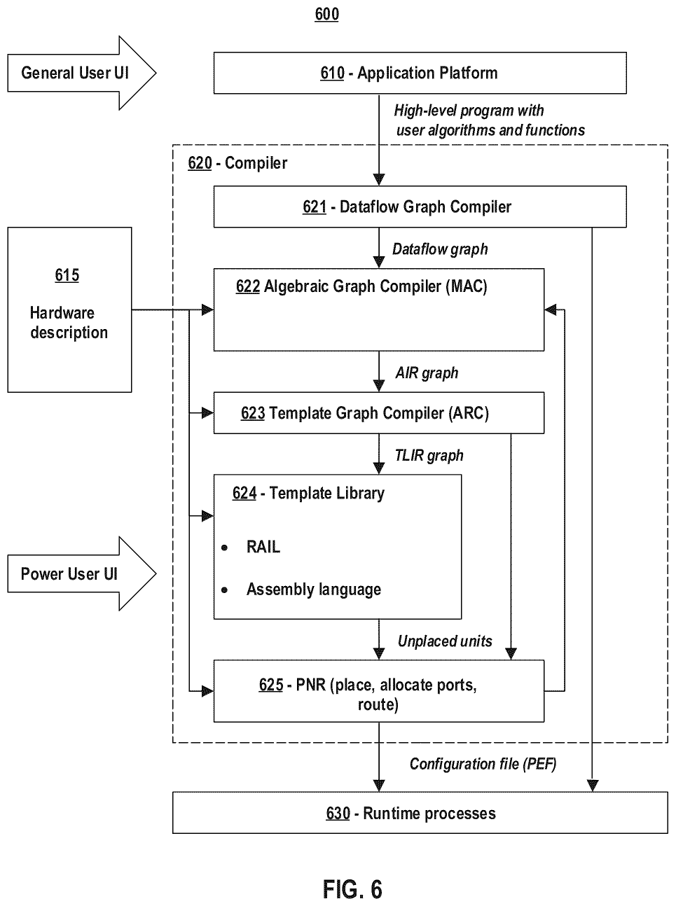

Compiler—a translator that processes statements written in a programming language to machine language instructions for a computer processor. A compiler may include multiple stages to operate in multiple steps. Individual stages may create or update an intermediate representation (IR) of the translated statements. Compiler stages are illustrated with reference to FIG. 6.

Computation graph—some algorithms can be represented as computation graphs. As used herein, computation graphs are a type of directed graphs comprising nodes that represent mathematical operations/expressions and edges that indicate dependencies between the operations/expressions. For example, with machine learning (ML) algorithms, input layer nodes assign variables, output layer nodes represent algorithm outcomes, and hidden layer nodes perform operations on the variables. Edges represent data (e.g., scalars, vectors, tensors) flowing between operations. In addition to dependencies, the computation graph reveals which operations and/or expressions can be executed concurrently.

CGR unit—a circuit that can be configured and reconfigured to locally store data (e.g., a memory unit or a PMU), or to execute a programmable function (e.g., a compute unit or a PCU). A CGR unit includes hardwired functionality that performs a limited number of functions used in computation graphs and dataflow graphs. Further examples of CGR units include a CU and an AG, which may be combined in an AGCU. Some implementations include CGR switches, whereas other implementations may include regular switches.

CU—coalescing unit.

Data Flow Graph—a computation graph that includes one or more loops that may be nested, and wherein nodes can send messages to nodes in earlier layers to control the dataflow between the layers.

Datapath—a collection of functional units that perform data processing operations. The functional units may include memory, multiplexers, ALUs, SIMDs, multipliers, registers, buses, etc.

FCMU—fused compute and memory unit—a circuit that includes both a memory unit and a compute unit.

Graph—a collection of nodes connected by edges. Nodes may represent various kinds of items or operations, dependent on the type of graph. Edges may represent relationships, directions, dependencies, etc.

IC—integrated circuit—a monolithically integrated circuit, i.e., a single semiconductor die which may be delivered as a bare die or as a packaged circuit. For the purposes of this document, the term integrated circuit also includes packaged circuits that include multiple semiconductor dies, stacked dies, or multiple-die substrates. Such constructions are now common in the industry, produced by the same supply chains, and for the average user often indistinguishable from monolithic circuits.

Logical CGR array or logical CGR unit—a CGR array or a CGR unit that is physically realizable, but that may not have been assigned to a physical CGR array or to a physical CGR unit on an IC.

Meta-pipeline—see pipeline.

ML—machine learning.

PCU—pattern compute unit—a compute unit that can be configured to repetitively perform a sequence of operations.

PEF—processor-executable format—a file format suitable for configuring a configurable data processor.

Pipeline—a staggered flow of operations through a chain of pipeline stages. The operations may be executed in parallel and in a time-sliced fashion. Pipelining increases overall instruction throughput. CGR processors may include pipelines at different levels. For example, a compute unit may include a pipeline at the gate level to enable correct timing of gate-level operations in a synchronous logic implementation of the compute unit, and a meta-pipeline at the graph execution level (typically a sequence of logical operations that are to be repetitively executed) that enables correct timing and loop control of node-level operations of the configured graph. Gate-level pipelines are usually hard wired and unchangeable, whereas meta-pipelines are configured at the CGR processor, CGR array level, and/or GCR unit level.

Pipeline Stages—a pipeline is divided into stages that are coupled with one another to form a pipe topology.

PMU—pattern memory unit-a memory unit that can store data according to a programmed pattern.

PNR—place and route—the assignment of logical CGR units and associated processing/operations to physical CGR units in an array, and the configuration of communication paths between the physical CGR units.

RAIL—reconfigurable dataflow processor (RDP) abstract intermediate language.

CGR Array—an array of CGR units, coupled with each other through an array-level network (ALN), and coupled with external elements via a top-level network (TLN). A CGR array can physically implement the nodes and edges of a dataflow graph.

SIMD—single-instruction multiple-data—an arithmetic logic unit (ALU) that simultaneously performs a single programmable operation on multiple data elements delivering multiple output results.

TLIR—template library intermediate representation.

TLN—top-level network.

### Implementations

The architecture, configurability and dataflow capabilities of an array of CGR units enable increased compute power that supports both parallel and pipelined computation. A CGR processor, which includes one or more CGR arrays (arrays of CGR units), can be programmed to simultaneously execute multiple independent and interdependent dataflow graphs. To enable simultaneous execution, the dataflow graphs may need to be distilled from a high-level program and translated to a configuration file for the CGR processor. A high-level program is source code written in programming languages like Spatial, Python, C++, and C, and may use computation libraries for scientific computing, ML, AI, and the like. The high-level program and referenced libraries can implement computing structures and algorithms of machine learning models like AlexNet, VGG Net, GoogleNet, ResNet, ResNeXt, RCNN, YOLO, SqueezeNet, SegNet, GAN, BERT, ELMo, USE, Transformer, and Transformer-XL.

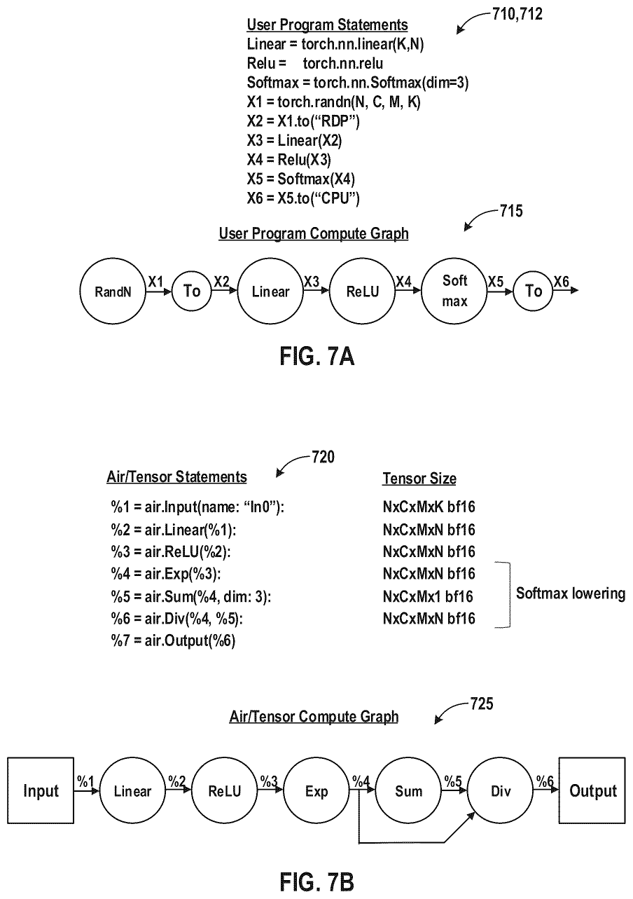

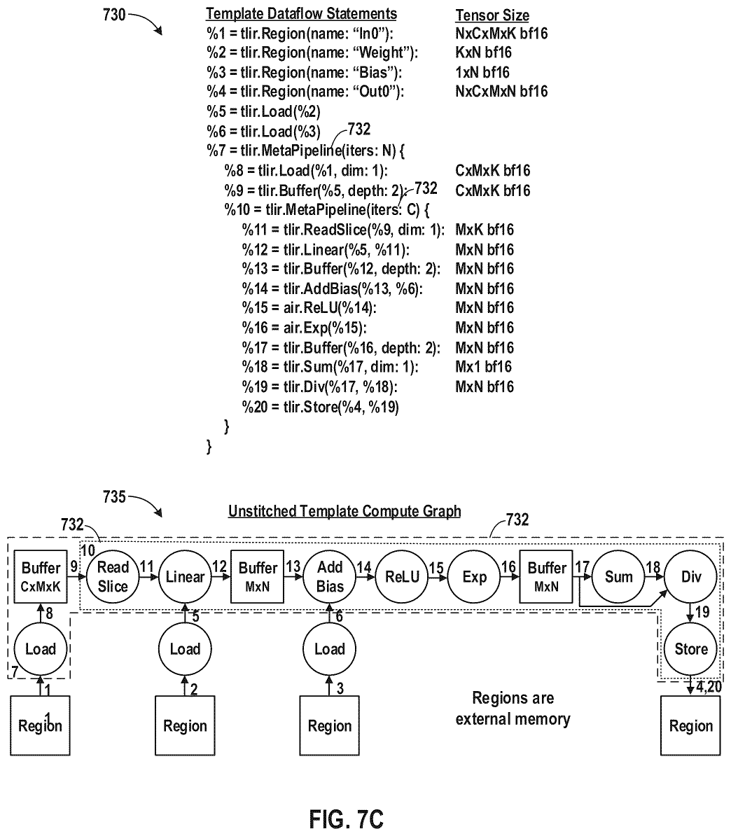

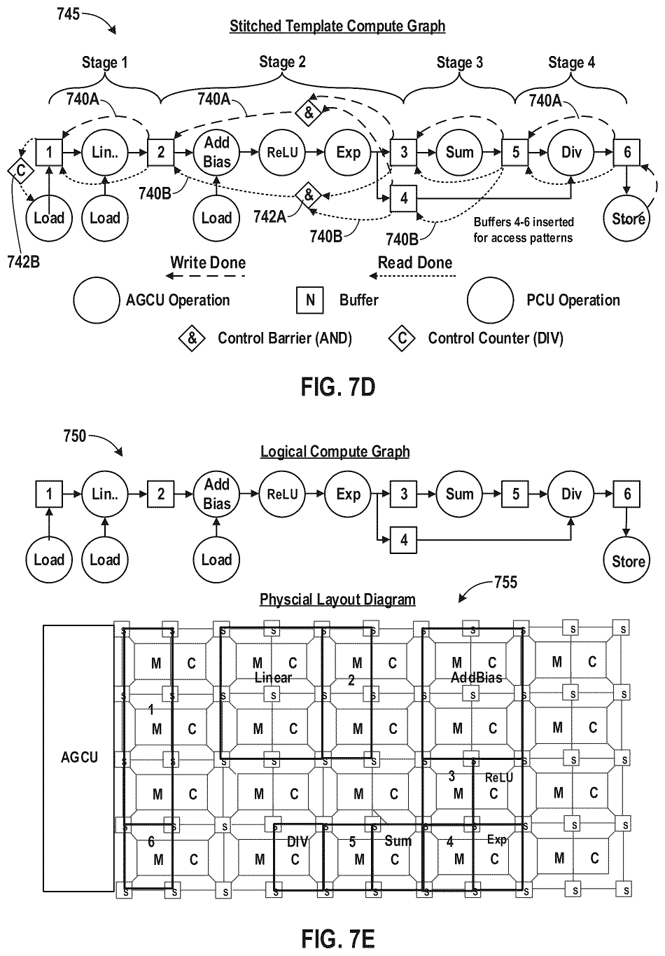

Translation of high-level programs to executable bit files is performed by a compiler. See, for example, FIGS. 6 and 7A-7E. While traditional compilers sequentially map operations to processor instructions, typically without regard to pipeline utilization and duration (a task usually handled by the hardware), an array of CGR units requires mapping operations to processor instructions in both space (for parallelism) and time (for synchronization of interdependent computation graphs or dataflow graphs). This requirement implies that a compiler for a CGRA must decide which operation of a computation graph or dataflow graph is assigned to which of the CGR units, and how both data and, related to the support of dataflow graphs, control information flows among CGR units, and to and from external hosts and storage. This process, known as “place and route”, is one of many new challenges posed to compilers for arrays of CGR units.

FIG. 1 illustrates an example coarse-grained reconfigurable architecture (CGRA) system 100 including a coarse-grained reconfigurable (CGR) processor 110 a compiler 160, runtime processes 170, a host 180, and a memory 190. CGR processor 110 includes a CGR array such as a CGR array 120. CGR array 120 includes an array of configurable units in an array level network. CGR processor 110 further includes an IO interface 138, and a memory interface 139. CGR array 120 is coupled with IO interface 138 and memory interface 139 through a data bus 130 which may be part of a top-level network (TLN). Host 180 communicates with IO interface 138 using a system data bus 185, and memory interface 139 communicates with memory 190 using a memory bus 195. A configurable unit in the CGR array 120 may comprise a compute unit or a memory unit. A configurable unit in the CGR array 120 may also comprise a pattern memory unit (PMU), a pattern compute unit (PCU), or a fused-compute memory unit (FCMU). Further examples include a coalescing unit (CU) and an address generator (AG), which may be combined in an AGCU. A configurable unit may also be reconfigurable.

The configurable units in the CGR array 120 may be connected with an array-level network (ALN) to provide the circuitry for execution of a computation graph or a dataflow graph that may have been derived from a high-level program with user algorithms and functions. The high-level program may include a set of procedures, such as learning or inferencing in an artificial intelligence (AI) or machine learning (ML) system. More specifically, the high-level program may include applications, graphs, application graphs, user applications, computation graphs, control flow graphs, dataflow graphs, models, deep learning applications, deep learning neural networks, programs, program images, jobs, tasks and/or any other procedures and functions that may need serial and/or parallel processing. In some implementations, execution of the graph(s) may involve using multiple CGR processors 110. In some implementations, CGR processor 110 may include one or more ICs. In other implementations, a single IC may span multiple CGR processors 110. In further implementations, CGR processor 110 may include multiple arrays of configurable units 120.

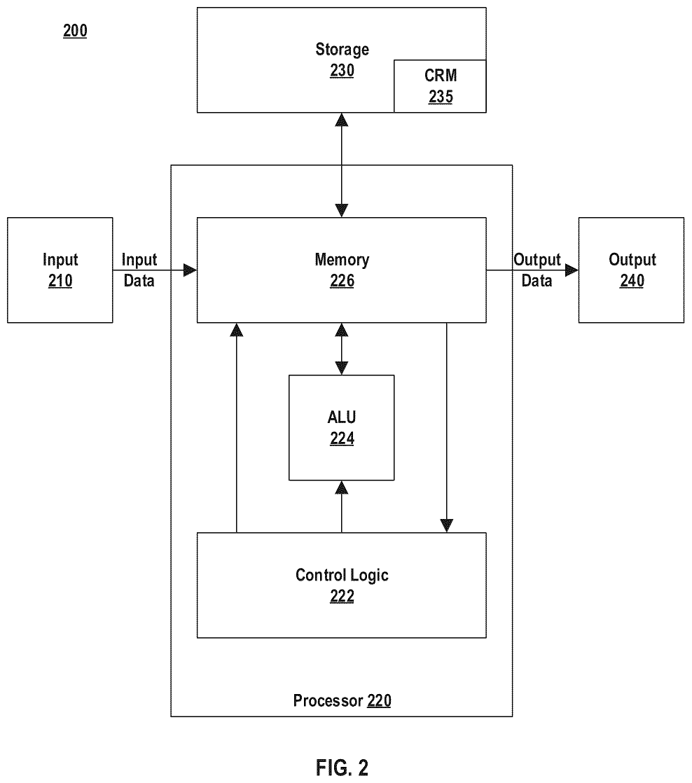

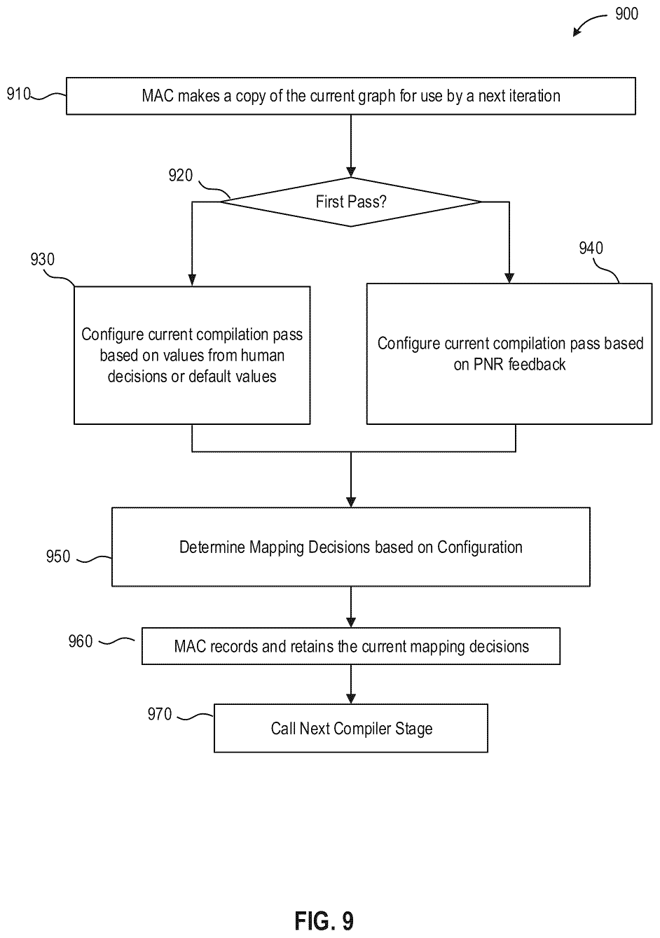

Host 180 may be, or include, a computer such as further described with reference to FIG. 2. Host 180 runs runtime processes 170, as further referenced herein, and may also be used to run computer programs, such as compiler 160 further described herein with reference to FIG. 9. In some implementations, compiler 160 may run on a computer that is similar to the computer described with reference to FIG. 2 but separate from host 180.

CGR processor 110 may accomplish computational tasks by executing a configuration file 165. Configuration file 165 may comprise a processor-executable format file suitable for configuring a CGR array 120 of a CGR processor 110. For the purposes of this description, a configuration file corresponds to a dataflow graph, or a translation of a dataflow graph, and may further include initialization data. Compiler 160 compiles the high-level program to provide the configuration file 165. In some implementations described herein, a CGR array 120 is configured by programming one or more configuration stores with all or parts of the configuration file 165. A single configuration store may be at the level of the CGR processor 110 or the CGR array 120, or a configurable unit may include an individual configuration store. The configuration file 165 may include configuration data for the CGR array 120 and the configurable units in the CGR array 120, and link the computation graph to the CGR array 120. Execution of the configuration file 165 by CGR processor 110 causes the array(s) of configurable units 120 (s) to implement the user algorithms and functions in the dataflow graph.

CGR processor 110 can be implemented on a single integrated circuit die or on a multichip module (MCM). An IC can be packaged in a single chip module or a multichip module. An MCM is an electronic package that may comprise multiple IC dies and other devices, assembled into a single module as if it were a single device. The various dies of an MCM may be mounted on a substrate, and the bare dies of the substrate are electrically coupled to the surface or to each other using for some examples, wire bonding, tape bonding or flip-chip bonding.

FIG. 2 illustrates an example of a computer 200, including an input device 210, a processor 220, a storage device 230, and an output device 240. Although the example computer 200 is drawn with a single processor, other implementations may have multiple processors. Input device 210 may comprise a mouse, a keyboard, a sensor, an input port (for example, a universal serial bus (USB) port), and any other input device known in the art. Output device 240 may comprise a monitor, printer, and any other output device known in the art. Furthermore, part or all of input device 210 and output device 240 may be combined in a network interface, such as a Peripheral Component Interconnect Express (PCIe) interface suitable for communicating with CGR processor 110. Input device 210 is coupled with processor 220 to provide input data, which an implementation may store in memory 226. Processor 220 is coupled with output device 240 to provide output data from memory 226 to output device 240. Processor 220 further includes control logic 222, operable to control memory 226 and arithmetic and logic unit (ALU) 224, and to receive program and configuration data from memory 226. Control logic 222 further controls exchange of data between memory 226 and storage device 230. Memory 226 typically comprises memory with fast access, such as static random-access memory (SRAM), whereas storage device 230 typically comprises memory with slow access, such as dynamic random-access memory (DRAM), flash memory, magnetic disks, optical disks, and any other memory type known in the art. At least a part of the memory in storage device 230 includes a non-transitory computer-readable medium (CRM 235), such as used for storing computer programs.

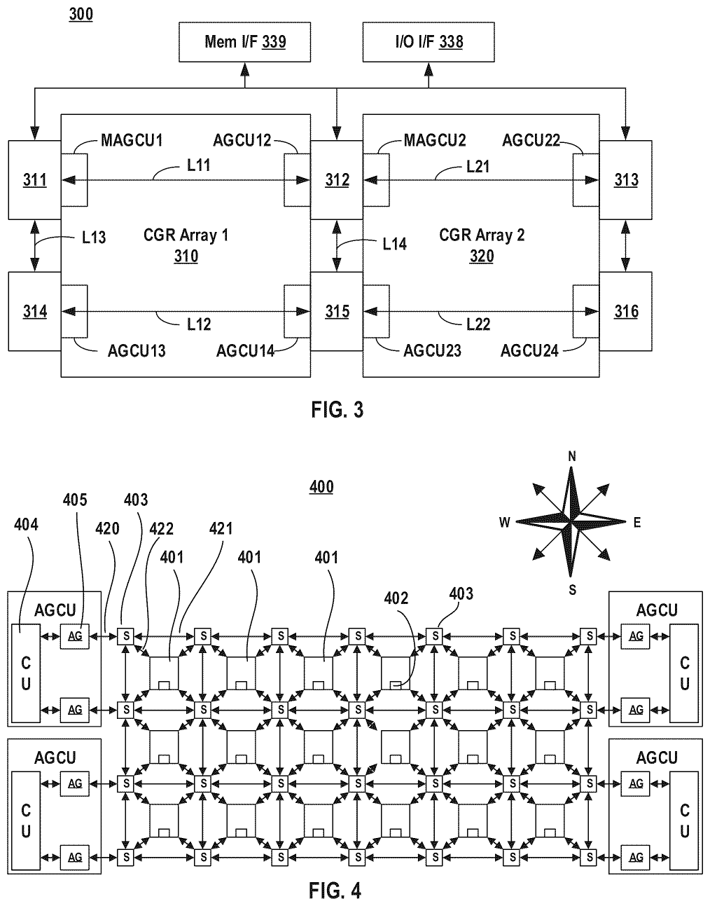

FIG. 3 illustrates example details of a CGR architecture 300 including a top-level network (TLN 330) and two CGR arrays (CGR array 310 and CGR array 320). A CGR array comprises an array of CGR units (e.g., PMUs, PCUs, FCMUs) coupled via an array-level network (ALN), e.g., a bus system. The ALN is coupled with the TLN 330 through several AGCUs, and consequently with I/O interface 338 (or any number of interfaces) and memory interface 339. Other implementations may use different bus or communication architectures.

Circuits on the TLN in this example include one or more external I/O interfaces, including I/O interface 338 and memory interface 339. The interfaces to external devices include circuits for routing data among circuits coupled with the TLN and external devices, such as high-capacity memory, host processors, other CGR processors, FPGA devices, and so on, that are coupled with the interfaces.

Each depicted CGR array has four AGCUs (e.g., MAGCU1, AGCU12, AGCU13, and AGCU14 in CGR array 310). The AGCUs interface the TLN to the ALNs and route data from the TLN to the ALN or vice versa.

One of the AGCUs in each CGR array in this example is configured to be a master AGCU (MAGCU), which includes an array configuration load/unload controller for the CGR array. The MAGCU1 includes a configuration load/unload controller for CGR array 310, and MAGCU2 includes a configuration load/unload controller for CGR array 320. Some implementations may include more than one array configuration load/unload controller. In other implementations, an array configuration load/unload controller may be implemented by logic distributed among more than one AGCU. In yet other implementations, a configuration load/unload controller can be designed for loading and unloading configuration of more than one CGR array. In further implementations, more than one configuration controller can be designed for configuration of a single CGR array. Also, the configuration load/unload controller can be implemented in other portions of the system, including as a stand-alone circuit on the TLN and the ALN or ALNs.

The TLN is constructed using top-level switches (switch 311, switch 312, switch 313, switch 314, switch 315, and switch 316) coupled with each other as well as with other circuits on the TLN, including the AGCUs, and external I/O interface 338. The TLN includes links (e.g., L11, L12, L21, L22) coupling the top-level switches. Data may travel in packets between the top-level switches on the links, and from the switches to the circuits on the network coupled with the switches. For example, switch 311 and switch 312 are coupled by link L11, switch 314 and switch 315 are coupled by link L12, switch 311 and switch 314 are coupled by link L13, and switch 312 and switch 313 are coupled by link L21. The links can include one or more buses and supporting control lines, including for example a chunk-wide bus (vector bus). For example, the top-level network can include data, request and response channels operable in coordination for transfer of data in any manner known in the art.

FIG. 4 illustrates an example CGR array 400, including an array of CGR units in an ALN. CGR array 400 may include several types of CGR unit 401, such as FCMUs, PMUs, PCUs, memory units, and/or compute units. For examples of the functions of these types of CGR units, see Prabhakar et al., “Plasticine: A Reconfigurable Architecture for Parallel Patterns”, ISCA 2017 June 24-28, 2017, Toronto, ON, Canada. Each of the CGR units may include a configuration store 402 comprising a set of registers or flip-flops storing configuration data that represents the setup and/or the sequence to run a program, and that can include the number of nested loops, the limits of each loop iterator, the instructions to be executed by individual stages, the source of operands, and the network parameters for the input and output interfaces. In some implementations, each CGR unit 401 comprises an FCMU. In other implementations, the array comprises both PMUs and PCUs, or memory units and compute units, arranged in a checkerboard pattern. In yet other implementations, CGR units may be arranged in different patterns. The ALN includes switch units 403 (S), and AGCUs (each including two address generators 405 (AG) and a shared coalescing unit 404 (CU)). Switch units 403 are connected among themselves via interconnects 421 and to a CGR unit 401 with interconnects 422. Switch units 403 may be coupled with address generators 405 via interconnects 420. In some implementations, communication channels can be configured as end-to-end connections, and switch units 403 are CGR units. In other implementations, switches route data via the available links based on address information in packet headers, and communication channels establish as and when needed.

A configuration file may include configuration data representing an initial configuration, or starting state, of individual CGR units that execute a high-level program with user algorithms and functions. Program load is the process of setting up the configuration stores in the CGR array based on the configuration data to allow the CGR units to execute the high-level program. Program load may also require loading memory units and/or PMUs.

The ALN includes one or more kinds of physical data buses, for example a chunk-level vector bus (e.g., 512 bits of data), a word-level scalar bus (e.g., 32 bits of data), and a control bus. For instance, interconnects 421 between two switches may include a vector bus interconnect with a bus width of 512 bits, and a scalar bus interconnect with a bus width of 32 bits. A control bus can comprise a configurable interconnect that carries multiple control bits on signal routes designated by configuration bits in the CGR array's configuration file. The control bus can comprise physical lines separate from the data buses in some implementations. In other implementations, the control bus can be implemented using the same physical lines with a separate protocol or in a time-sharing procedure.

Physical data buses may differ in the granularity of data being transferred. In one implementation, a vector bus can carry a chunk that includes 16 channels of 32-bit floating-point data or 32 channels of 16-bit floating-point data (i.e., 512 bits) of data as its payload. A scalar bus can have a 32-bit payload and carry scalar operands or control information. The control bus can carry control handshakes such as tokens and other signals. The vector and scalar buses can be packet-switched, including headers that indicate a destination of individual packets and other information such as sequence numbers that can be used to reassemble a file when the packets are received out of order. Individual packet headers can contain a destination identifier that identifies the geographical coordinates of the destination switch unit (e.g., the row and column in the array), and an interface identifier that identifies the interface on the destination switch (e.g., North, South, East, West, etc.) used to reach the destination unit.

A CGR unit 401 may have four ports (as drawn) to interface with switch units 403, or any other number of ports suitable for an ALN. Individual ports may be suitable for receiving and transmitting data, or a port may be suitable for only receiving or only transmitting data.

A switch unit, as shown in the example of FIG. 4, may have eight interfaces. The North, South, East and West interfaces of a switch unit may be used for links between switch units using interconnects 421. The Northeast, Southeast, Northwest and Southwest interfaces of a switch unit may each be used to make a link with an FCMU, PCU or PMU instance using one of the interconnects 422. Two switch units in each CGR array quadrant have links to an AGCU using interconnects 420. The AGCU coalescing unit arbitrates between the AGs and processes memory requests. Individual interfaces of a switch unit can include a vector interface, a scalar interface, and a control interface to communicate with the vector network, the scalar network, and the control network. In other implementations, a switch unit may have any number of interfaces.

During execution of a graph or subgraph in a CGR array after configuration, data can be sent via one or more switch units and one or more links between the switch units to the CGR units using the vector bus and vector interface(s) of the one or more switch units on the ALN. A CGR array may comprise at least a part of CGR array 400, and any number of other CGR arrays coupled with CGR array 400.

A data processing operation implemented by CGR array configuration may comprise multiple graphs or subgraphs specifying data processing operations that are distributed among and executed by corresponding CGR units (e.g., FCMUs, PMUs, PCUs, AGs, and CUs).

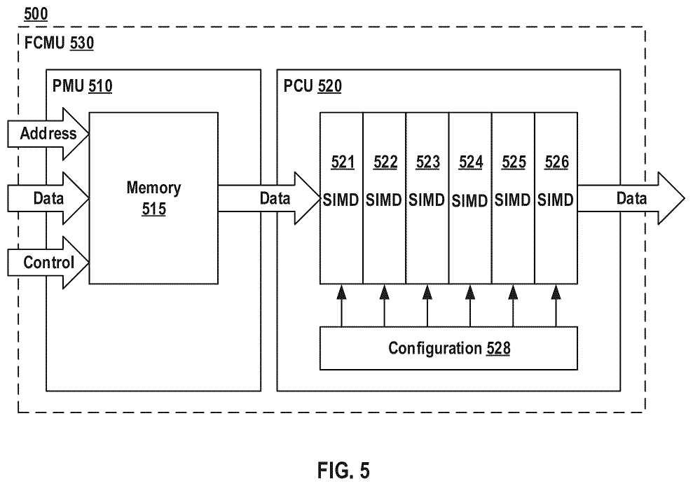

FIG. 5 illustrates an example 500 of a PMU 510 and a PCU 520, which may be combined in an FCMU 530. PMU 510 may be directly coupled to PCU 520, or optionally via one or more switches. PMU 510 includes a scratchpad memory 515, which may receive external data, memory addresses, and memory control information (write enable, read enable) via one or more buses included in the ALN. PCU 520 includes two or more processor stages, such as SIMD 521 through SIMD 526, and configuration store 528. The processor stages may include ALUs, or SIMDs, as drawn, or any other reconfigurable stages that can process data.

Individual stages in PCU 520 may also hold one or more registers (not drawn) for short-term storage of parameters. Short-term storage, for example during one to several clock cycles or unit delays, allows for synchronization of data in the PCU pipeline.

Referring now to FIG. 6 which is a block diagram of a compiler stack 600 implementation suitable for generating a configuration file for a CGR processor. Referring also to FIGS. 7A-7E which illustrate various representations of an example user program 710 corresponding to various stages of a compiler stack such as the compiler stack 600. As depicted, compiler stack 600 includes several stages to convert a high-level program (e.g., user program 710) with statements 712 that define user algorithms and functions, e.g., algebraic expressions and functions, to configuration data for the CGR units.

Compiler stack 600 may take its input from application platform 610, or any other source of high-level program statements suitable for parallel processing, which provides a user interface for general users. It may further receive hardware description 615, for example defining the physical units in a reconfigurable data processor or CGRA processor. Application platform 610 may include libraries such as PyTorch, TensorFlow, ONNX, Caffe, and Keras to provide user-selected and configured algorithms. The example user program 710 depicted in FIG. 7A comprises statements 712 that invoke various PyTorch functions.

Application platform 610 outputs a high-level program to compiler 620, which in turn outputs a configuration file to the reconfigurable data processor or CGRA processor where it is executed in runtime processes 630. Compiler 620 may include dataflow graph compiler 621, which may handle a dataflow graph, algebraic graph compiler 622, template graph compiler 623, template library 624, and placer and router (PNR) 625. In some implementations, template library 624 includes RDP abstract intermediate language (RAIL) and/or assembly language interfaces for power users.

Dataflow graph compiler 621 converts the high-level program with user algorithms and functions from application platform 610 to one or more dataflow graphs. The high-level program may be suitable for parallel processing, and therefore parts of the nodes of the dataflow graphs may be intrinsically parallel unless an edge in the graph indicates a dependency. Dataflow graph compiler 621 may provide code optimization steps like false data dependency elimination, dead-code elimination, and constant folding. The dataflow graphs encode the data and control dependencies of the high-level program.

Dataflow graph compiler 621 may support programming a reconfigurable data processor at higher or lower-level programming languages, for example from an application platform 610 to C++ and assembly language. In some implementations, dataflow graph compiler 621 allows programmers to provide code that runs directly on the reconfigurable data processor. In other implementations, dataflow graph compiler 621 provides one or more libraries that include predefined functions like linear algebra operations, element-wise tensor operations, non-linearities, and reductions required for creating, executing, and profiling the dataflow graphs on the reconfigurable processors. Dataflow graph compiler 621 may provide an application programming interface (API) to enhance functionality available via the application platform 610.

Algebraic graph compiler 622 may include a model analyzer and compiler (MAC) level that makes high-level mapping decisions for (sub-graphs of the) dataflow graph based on hardware constraints. It may support various application frontends such as Samba, JAX, and TensorFlow/HLO. Algebraic graph compiler 622 may also transform the graphs via autodiff and GradNorm, perform stitching between sub-graphs, interface with template generators for performance and latency estimation, convert dataflow graph operations to AIR operation, perform tiling, sharding (database partitioning) and other operations, and model or estimate the parallelism that can be achieved on the dataflow graphs.

Algebraic graph compiler 622 may further include an arithmetic or algebraic intermediate representation (AIR) stage that translates high-level graph and mapping decisions provided by the MAC level into explicit AIR/Tensor statements 720 and one or more corresponding algebraic graphs 725 as shown in FIG. 7B. In the depicted example, the algebraic graph compiler replaces the Softmax function specified in the user program 710 by its constituent statements/nodes (i.e., exp, sum and div). Key responsibilities of the AIR level include legalizing the graph and mapping decisions of the MAC, expanding data parallel, tiling, meta-pipe, region instructions provided by the MAC, inserting stage buffers and skip buffers, eliminating redundant operations, buffers and sections, and optimizing for resource use, latency, and throughput.

Template graph compiler 623 may translate AIR statements and/or graphs into TLIR statements 730 and/or graph(s) 735 (see FIG. 7C), optimizing for the target hardware architecture, into unplaced variable-sized units (referred to as logical CGR units) suitable for PNR 625. Meta-pipelines 732 that enable iteration control may be allocated for sections of the TLIR statements and/or corresponding sections of the graph(s) 735. Template graph compiler 623 may add further information (e.g., name, inputs, input names and dataflow description) for PNR 625 and make the graph physically realizable through each performed step. Template graph compiler 623 may for example provide translation of AIR graphs to specific model operation templates such as for general matrix multiplication (GeMM). An implementation may convert part or all intermediate representation operations to templates, stitch templates into the dataflow and control flow, insert necessary buffers and layout transforms, generate test data and optimize for hardware use, latency, and throughput.

Implementations may use templates for common operations. Templates may be implemented using assembly language, RAIL, or similar. RAIL is comparable to assembly language in that memory units and compute units are separately programmed, but it can provide a higher level of abstraction and compiler intelligence via a concise performance-oriented domain-specific language for CGR array templates. RAIL enables template writers and external power users to control interactions between logical compute units and memory units with high-level expressions without the need to manually program capacity splitting, register allocation, etc. The logical compute units and memory units also enable stage/register allocation, context splitting, transpose slotting, resource virtualization and mapping to multiple physical compute units and memory units (e.g., PCUs and PMUs).

Template library 624 may include an assembler that provides an architecture-independent low-level programming interface as well as optimization and code generation for the target hardware. Responsibilities of the assembler may include address expression compilation, intra-unit resource allocation and management, making a template graph physically realizable with target-specific rules, low-level architecture-specific transformations and optimizations, and architecture-specific code generation.

Referring to FIG. 7D, the template graph compiler may also determine the control signals 740 and control gates 742 required to enable the CGR units (whether logical or physical) to coordinate dataflow between the CGR units on the communication fabric of a CGR processor. This process, sometimes referred to as stitching, produces a stitched template compute graph 745 with control signals 740 and control gates 742. In the example depicted in FIG. 7D, the control signals 740 include write done signals 740A and read done signals 740B and the control gates 742 include ‘AND’ gates 742A and a counting or ‘DIV’ gate 742B. The control signals 740 and control gates 742 enable coordinated dataflow between the configurable units of CGR processors such as compute units, memory units, and AGCUs.

PNR 625 translates and maps logical (i.e., unplaced physically realizable) CGR units (e.g., the nodes of the logical compute graph 750 shown in FIG. 7E) to a physical layout (e.g., the physical layout 755 shown in FIG. 7E) on the physical chip level e.g., a physical array of CGR units. PNR 625 also determines physical data channels to enable communication among the CGR units and between the CGR units and circuits coupled via the TLN, allocates ports on the CGR units and switches, provides configuration data and initialization data for the target hardware, and produces configuration files, e.g., processor-executable format (PEF) files. It may further provide bandwidth calculations, allocate network interfaces such as AGCUs and virtual address generators (VAGs), provide configuration data that allows AGCUs and/or VAGs to perform address translation, and control ALN switches and data routing. PNR 625 may provide its functionality in multiple steps and may include multiple modules (not shown in FIG. 6) to provide the multiple steps, e.g., a placer, a router, a port allocator, and a PEF file generator. PNR 625 may receive its input data in various ways. For example, it may receive parts of its input data from any of the earlier modules (dataflow graph compiler 621, algebraic graph compiler 622, template graph compiler 623, and/or template library 624). In some implementations, an earlier module, such as template graph compiler 623, may have the task of preparing all information for PNR 625 and no other units provide PNR input data directly.

Further implementations of compiler 620 provide for an iterative process, for example by feeding information from PNR 625 back to an earlier module, so that the earlier module can execute a new compilation step in which it uses physically realized results rather than estimates of or placeholders for physically realizable circuits. For example, PNR 625 may feed information regarding the physically realized circuits back to algebraic graph compiler 622.

Memory allocations represent the creation of logical memory spaces in on-chip and/or off-chip memories for data required to implement the dataflow graph, and these memory allocations are specified in the configuration file. Memory allocations define the type and the number of hardware circuits (functional units, storage, or connectivity components). Main memory (e.g., DRAM) may be off-chip memory, and scratchpad memory (e.g., SRAM) is on-chip memory inside a CGR array. Other memory types for which the memory allocations can be made for various access patterns and layouts include cache, read-only look-up tables (LUTs), serial memories (e.g., FIFOs), and register files.

Compiler 620 binds memory allocations to unplaced memory units and binds operations specified by operation nodes in the dataflow graph to unplaced compute units, and these bindings may be specified in the configuration data. In some implementations, compiler 620 partitions parts of a dataflow graph into memory subgraphs and compute subgraphs, and specifies these subgraphs in the PEF file. A memory subgraph may comprise address calculations leading up to a memory access. A compute subgraph may comprise all other operations in the parent graph. In one implementation, a parent graph is broken up into multiple memory subgraphs and exactly one compute subgraph. A single parent graph can produce one or more memory subgraphs, depending on how many memory accesses exist in the original loop body. In cases where the same memory addressing logic is shared across multiple memory accesses, address calculation may be duplicated to create multiple memory subgraphs from the same parent graph.

Compiler 620 generates the configuration files with configuration data (e.g., a bit stream) for the placed positions and the routed data and control networks. In one implementation, this includes assigning coordinates and communication resources of the physical CGR units by placing and routing unplaced units onto the array of CGR units while maximizing bandwidth and minimizing latency.

A first example of accelerated deep learning is using a deep learning accelerator implemented in a CGRA to train a neural network. A second example of accelerated deep learning is using the deep learning accelerator to operate a trained neural network to perform inferences. A third example of accelerated deep learning is using the deep learning accelerator to train a neural network and subsequently perform inference with any one or more of the trained neural network, information from the trained neural network, and a variant of the same.

Examples of neural networks include fully connected neural networks (FCNNs), recurrent neural networks (RNNs), graph neural networks (GNNs), convolutional neural networks (CNNs), graph convolutional networks (GCNs), long short-term memory (LSTM) networks, autoencoders, deep belief networks, and generative adversarial networks (GANs).

An example of training a neural network is determining one or more weights associated with the neural network, such as by back-propagation in a deep learning accelerator. An example of making an inference is using a trained neural network to compute results by processing input data using the weights associated with the trained neural network. As used herein, the term ‘weight’ is an example of a ‘parameter’ as used in various forms of neural network processing. For example, some neural network learning is directed to determining parameters (e.g., through back-propagation) that are usable for performing neural network inferences.

A neural network processes data according to a dataflow graph comprising layers of neurons. Example layers of neurons include input layers, hidden layers, and output layers. Stimuli (e.g., input data) are received by an input layer of neurons and the computed results of the dataflow graph (e.g., output data) are provided by an output layer of neurons. Example hidden layers include rectified linear unit (ReLU) layers, fully connected layers, recurrent layers, graphical network layers, long short-term memory layers, convolutional layers, kernel layers, dropout layers, and pooling layers. A neural network may be conditionally and/or selectively trained. After being trained, a neural network may be conditionally and/or selectively used for inference.

Examples of ICs, or parts of ICs, that may be used as deep learning accelerators, are processors such as central processing unit (CPUs), CGR processor ICs, graphics processing units (GPUs), FPGAs, ASICs, application-specific instruction-set processor (ASIP), and digital signal processors (DSPs). The disclosed technology implements efficient distributed computing by allowing an array of accelerators (e.g., reconfigurable processors) attached to separate hosts to directly communicate with each other via buffers.

FIG. 8 is a flowchart of one example of a compute graph compilation method 800 for a CGR dataflow computing system. The method 800 includes iterative feedback to different compiler stages (e.g., from PNR to MAC or ARC). The computer-implemented compute graph compilation method 800 contributes to overall improvement in compilation and performance in a CGR dataflow computing system.

At block 810, the MAC of the algebraic graph compiler may perform high-level mapping decisions for (sub-graphs of) a dataflow graph based on hardware constraints. For example, the MAC may perform the high-level mapping decisions (e.g., section cuts, parallelization (PAR) factors, etc.) using a resource estimation model. The algebraic graph compiler may also transform the graphs via autodiff and GradNorm, perform stitching between sub-graphs, interface with template generators for performance and latency estimation, convert dataflow graph operations to AIR operation, perform tiling, sharding (database partitioning) and other operations, and model or estimate the parallelism that can be achieved on the dataflow graphs. Algebraic graph compiler may further include an arithmetic or algebraic intermediate representation (AIR) stage that translates high-level graph and mapping decisions provided by the MAC level into explicit AIR/Tensor statements and one or more corresponding algebraic graphs.

The MAC or algebraic graph compiler may also make a copy of the current graph for a next iteration to use. This may be needed to revert graph transformations that occur during or after MAC makes mapping decisions (e.g., recompute node insertion). In addition, the MAC may record and retain the current mapping decisions. Additional discussion of the operations of the algebraic graph compiler is provided below with respect to FIG. 9.

At block 820, the ARC of the template graph compiler may, based on the output of the algebraic graph compiler, determine template library intermediate representation statements or graphs to be placed and routed by the PNR. For example, the ARC may translate AIR statements and/or graphs into TLIR statements and/or graph(s), optimizing for the target hardware architecture, into unplaced variable-sized units (referred to as logical CGR units) suitable for the PNR. Meta-pipelines that enable iteration control may be allocated for sections of the TLIR statements and/or corresponding sections of the graph(s). Template graph compiler may add further information (e.g., name, inputs, input names and dataflow description) for the PNR and make the graph physically realizable through each performed step. Template graph compiler may, for example, provide translation of AIR graphs to specific model operation templates such as for general matrix multiplication (GeMM). An implementation may convert part or all intermediate representation operations to templates, stitch the templates into the dataflow and control flow, insert necessary buffers and layout transforms, generate test data and optimize for hardware use, latency, and throughput.

At block 830, the PNR may translate and map logical (i.e., unplaced physically realizable) CGR units (e.g., the nodes of the logical compute graph) to a physical layout (e.g., the physical layout) on the physical chip level e.g., a physical array of CGR units. The PNR also determines physical data channels to enable communication among the CGR units and between the CGR units and circuits coupled via the TLN, allocates ports on the CGR units and switches, provides configuration data and initialization data for the target hardware, and produces configuration files, e.g., processor-executable format (PEF) files. It may further provide bandwidth calculations, allocate network interfaces such as AGCUs and virtual address generators (VAGs), provide configuration data that allows AGCUs and/or VAGs to perform address translation, and control ALN switches and data routing. The PNR may provide its functionality in multiple steps and may include multiple modules (not shown in FIG. 6) to provide the multiple steps, e.g., a placer, a router, a port allocator, and a PEF file generator. The PNR may receive its input data in various ways. For example, it may receive parts of its input data from any of the earlier modules (e.g., dataflow graph compiler, algebraic graph compiler, template graph compiler, and/or template library). In some, an earlier module, such as a template graph compiler, may have the task of preparing all information for the PNR and other units may not be configured to provide PNR input data directly.

Further implementations of compiler provide for an iterative process, for example, by feeding information from the PNR back to an earlier module so that the earlier module can execute a new compilation step in which it uses physically realized results rather than estimates of or placeholders for physically realizable circuits. For example, PNR may feed information regarding the physically realized circuits back to algebraic graph compiler (e.g., the MAC) or to the template graph compiler (e.g., the ARC).

More particularly, at block 840, the compiler (e.g., the PNR) may determine whether the place and route operation finished successfully or failed. If the PNR operation succeeded, the process may continue to 845 where the compilation operation may exit or proceed normally (e.g., with additional iterations or optimizations). Otherwise, the process may continue to 850 for failure handling. For example, the PNR may hit an un-placeable or un-routable issue due to hardware or software limitations and the compilation process may need to be iterated to adjust and finish compilation.

At block 850, the PNR may determine the type of failure or issue. For example, some issues are due to sub-optimal upstream scheduling and can be resolved in upstream modules.

As mentioned previously, the MAC may determine sections of the dataflow graph. The compilation process of 810-840 may be performed iteratively on a per section basis where the sections are stitched together and/or connected by the various compilation and place and route operations. In addition, the compilation operations may be performed in parallel or in batches which may handle multiple sections at a time. Thus, the failure check at block 840 may stop the compilation at the earliest time a section fails to reduce wasted processing resources.

The PNR failure analysis and feedback operations discussed with respect to block 850-880 may also be per section or partition. More particularly, using the information determined at block 850, the compilation process may pinpoint the section or partition with issues and may return to the appropriate upstream modules to adjust accordingly. Other sections (e.g., sections placed and routed with no issue prior to the failing section or partition or parallel thereto) may be kept and not reanalyzed and/or recompiled on further iterations.

At block 860, the compilation process may determine whether the failure of the section is resolvable by the MAC. For example, the MAC's resource estimation may be significantly off from the actual resource usage that occurred during the PNR operation. In some examples, this may occur because graph transformations performed in lower layers (e.g., ARC inserted buffers) are not visible to MAC. This may lead to underestimation of PCU/PMU usage and therefore result in invalid mapping decisions (e.g., too many nodes in a section) which may in turn cause PNR failures. If the failure is resolvable by the MAC, the process may continue to block 865 where the information regarding the failure may be prepared for usage by the MAC at block 810. Otherwise, the process may continue to block 870.

At block 870, the compilation process may determine whether the failure of the section is resolvable by the ARC. For example, the ARC may include some GEMM templates in a fast-bypass mode in the template library intermediate representation. The PNR may not support unboxing GEMM templates in a fast-bypass mode because of the assumption of the fast-bypass path. In some cases, GEMM templates in a fast-bypass mode may not affect the stitching of the template but may change the template's internal units' connectivity. The lack of support for unboxing may lead to PNR failures. It may be difficult to undo the effect of the fast-bypass after the unit network has been created. For example, when a template library intermediate representation of a section has GEMM boxes which cannot fit four (4) tiles, the PNR may need some of the GEMMs unboxed to fit the critical boxes of the target hardware. It may be more efficient or less resource intensive to reconstruct the section with toggling of the fast-bypass mode in order to unbox the GEMM template. In such a case, if the PNR wants to unbox certain GEMMs, it can feedback to ARC (e.g., to an in-memory code generator (IMCG) of the template library graph compiler to do so).

If the failure is resolvable by the ARC, the process may continue to block 875 where the information regarding the failure may be prepared for usage by the ARC at block 820. For example, if the PNR determines that there is not a need to change the section stitching, the information for the ARC may indicate that the iterative loop up to ARC may be limited to-memory code generator (IMCG). Otherwise, the process may continue to block 880 where the process may exit with failure (e.g., because the compilation error is not determined to be resolvable).

While not shown for ease of understanding, in some examples, the PNR may determine the issue is one which may be addressed efficiently in the PNR. In this case, the PNR may iterate on the current information provided by the earlier modules to handle the issue without returning to the earlier modules.

FIG. 9 is a flowchart of one example of a compute graph compilation for a CGR dataflow computing system. The method 900 includes the operations of the algebraic graph compiler in an example with iterative feedback from the PNR to different compiler stages (e.g., from PNR to MAC or ARC). The computer-implemented compute graph compilation method 900 contributes to overall improvement in compilation and performance in a CGR dataflow computing system.

At 910, the MAC of the algebraic graph compiler may make a copy of the current dataflow graph for use by a next iteration. The copy of the current dataflow graph may be needed for the next iteration to revert graph transformations that occur during or after MAC makes mapping decisions (e.g., to recompute node insertion).

At block 920, the MAC may determine if this is a first pass or otherwise not a pass initiated by the PNR. If so, the process may continue to 930. Otherwise, the process may continue to 940.

At block 930, the MAC may use values from human decisions or default values to configure the current compilation pass. For example, a resource scale factor may be set to the default or specified value (e.g., specified by human or algorithmically) and the nodes to be mapped in the current pass may be set to all nodes in the dataflow graph. The process may continue to block 950.

Returning to block 940, the MAC may use values from the PNR feedback to configure the current compilation pass. For example, the MAC may determine a resource scale factor for the first failed section. The MAC may then set the nodes to be mapped to the first failed section and all the nodes in following sections. In a particular example where the compilation is based on section categories (e.g., forward propagation, backward propagation, gradient normalization or optimization), the MAC may utilize the PNR feedback to set a resource scale factor for the first failed section and the nodes to be mapped may be set to the first failed section and all the nodes in the subsequent sections in the same section category. The process may continue to block 950.

At block 950, the MAC may determine mapping decisions (e.g., section cuts, parallelization (PAR) factors, etc.) for the nodes to be mapped and the resource scale factor for the first failed section. At block 960, the MAC may record and retain the current mapping decisions. Next, at block 970, the MAC may call the next compiler stage based on the current mapping decisions. For example, the MAC may call the AIR or ARC compiler stage.

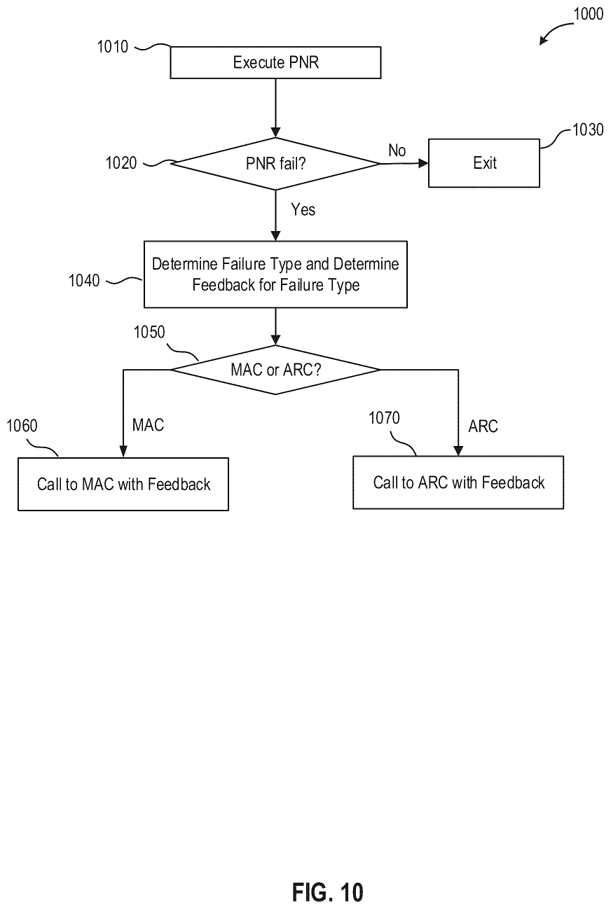

FIG. 10 is a flowchart of one example of a compute graph compilation for a CGR dataflow computing system. The method 1000 includes the operations of the PNR handling of a place and route failure in an example with iterative feedback from the PNR to different compiler stages (e.g., from PNR the to the MAC or the ARC). The computer-implemented compute graph compilation method 1000 contributes to overall improvement in compilation and performance in a CGR dataflow computing system.

At block 1010, the PNR may perform place and route operations for template library intermediate representation statements or graphs provided by the previous compiler stage (e.g., the template graph compiler). For example, the PNR may translate and map logical (i.e., unplaced physically realizable) CGR units (e.g., the nodes of the logical compute graph to a physical layout (e.g., the physical layout) on the physical chip level e.g., a physical array of CGR units. The PNR also determines physical data channels to enable communication among the CGR units and between the CGR units and circuits coupled via the TLN, allocates ports on the CGR units and switches, provides configuration data and initialization data for the target hardware, and produces configuration files, e.g., processor-executable format (PEF) files. It may further provide bandwidth calculations, allocate network interfaces such as AGCUs and virtual address generators (VAGs), provide configuration data that allows AGCUs and/or VAGs to perform address translation, and control ALN switches and data routing. The PNR may provide its functionality in multiple steps and may include multiple modules to provide the multiple steps, e.g., a placer, a router, a port allocator, and a PEF file generator. The PNR may receive its input data in various ways. For example, it may receive parts of its input data from any of the earlier modules (e.g., dataflow graph compiler, algebraic graph compiler, template graph compiler, and/or template library). In some implementations, an earlier module, such as template graph compiler, may have the task of preparing information for the PNR and other units may provide no PNR input data directly.

At block 1020, the compiler (e.g., the PNR) may determine whether the place and route operation finished successfully or failed. For example, implementations of the compiler may provide for an iterative process by feeding information from the PNR back to an earlier module, so that the earlier module can execute a new compilation step in which it uses physically realized results rather than estimates of or placeholders for physically realizable circuits. For example, the PNR may feed information regarding the physically realized circuits back to algebraic graph compiler (e.g., the MAC) or to the template graph compiler (e.g., the ARC).

If the PNR operation succeeded, the process may continue to 1030 where the compilation operation may exit or proceed normally (e.g., with additional iterations or optimizations). Otherwise, the process may continue to 1040 for failure handling.

At 1040, the PNR may determine the type of failure or issue and feedback for the determine failure type. For example, some issues may be due to sub-optimal upstream scheduling and can be resolved in upstream modules. Depending on the details of the issue, different upstream modules may be more efficient at handling the issue.

At block 1050, the compilation process may determine whether the failure of the section is resolvable by the MAC or the ARC. For example, the MAC's resource estimation may be significantly off from the actual resource usage that occurred during the PNR operation. In some examples, this may occur because graph transformations performed in lower layers (e.g., ARC inserted buffers) are not visible to MAC. This may lead to underestimation of PCU/PMU usage and therefore resulting in invalid mapping decisions (e.g., too many nodes in a section), which in turn may cause PNR failures.

In another example, the ARC may have included0 some GEMM templates in a fast-bypass mode in the current template library intermediate representation input to the PNR. The PNR may not support unboxing because GEMM templates in a fast-bypass mode assume the presence of a fast-bypass path. In some cases, GEMM templates in a fast-bypass mode may not affect the stitching of the template but may changes the template's internal units' connectivity. The lack of support for unboxing may lead to PNR failures. It may be very difficult to undo the effect of the fast-bypass after the unit network has been created. For example, when a section has GEMM boxes which cannot fit four (4) tiles, the PNR may need some of the GEMMs unboxed to fit the critical boxes of the target hardware. It may be more efficient or less resource intensive to reconstruct the section with toggling of the fast-bypass mode to unbox the GEMM template. In such a case, if the PNR wants to unbox certain GEMMs, it can indicate this in failure feedback to the ARC to do so.

If the failure is resolvable by the MAC, the process may continue to block 1060 where the information regarding the failure may be prepared for usage by the MAC and returned to the MAC. Otherwise, if the failure is resolvable by the ARC, the process may continue to block 1070 where the information regarding the failure may be prepared for usage by the ARC and returned to the ARC.

For example, in a scenario in which compilation is to returned to the MAC for additional processing because a section exceeded a hardware capacity, the PNR may cause a callback to the MAC with an error code indicating that PNR failed for a section due to not having enough resources. The PNR may also store all section's PMU/PCU usage and mark each section as failing or not failing due to not having enough resource. Further, PNR may indicate the successfully compiled sections to the ARC or MAC and store the compiled sections for use by the PNR on subsequent iterations.

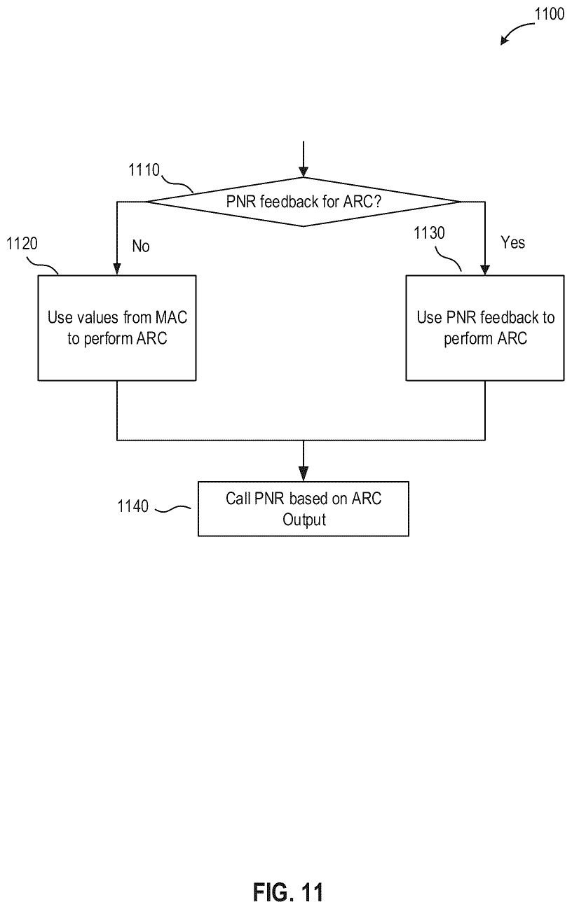

FIG. 11 is a flowchart of one example of a compute graph compilation for a CGR dataflow computing system. The method 1100 includes the operations of the template graph compiler in an example with iterative feedback from the PNR to different compiler stages (e.g., from PNR to MAC or ARC). The computer-implemented compute graph compilation method 1100 contributes to overall improvement in compilation and performance in a CGR dataflow computing system.

At block 1110, the ARC may determine if this pass was initiated by the PNR (e.g. PNR feedback provided for adjusting the ARC operation on this pass). If not (e.g., called by the MAC), the process may continue to 1120. Otherwise, the process may continue to 1130.

At block 1120, the ARC may use values from the MAC or other previous compiler stage to configure and perform ARC operations. The process may continue to block 1140.

Returning to block 1130, the ARC may use values from the PNR feedback in addition to the input data from previous compiler stages (e.g., from the MAC) to configure and perform ARC operations. The process may continue to block 1140.

At block 1140, the ARC may initiate PNR processing based on the output of the current pass of the ARC.

It should be noted that the above discussion relates to examples in which a failure check is performed after the PNR stage or other stage finishes operations for the particular stage or section. However, examples are not so limited. For example, the triggering of the feedback mechanism may occur at various points in compilation such as upon the first failure among parallel compilation of multiple sections, after a plurality of sections have failed to compile or upon determination that the compilation has more than a threshold chance of failure (e.g., a determination that the allocated resources for a section is too low before the actual occurrence of an error or before the actual placement and routing operation). Similarly, the particular portion of a previous stage of the compiler to which the compilation operation is returned may vary. As an example, where the particular failure is a determination that the allocated resources for a section is too low and is detected by an early stage of the PNR operation (e.g., during PRISM operations before the placement and routing operation begins), the feedback mechanism described herein may trigger and provide feedback to a different stage of the algebraic graph compiler (e.g., to the AIR or MAC).

Further, examples are not limited to the particular stages or modules discussed herein. Rather, the compiler may be divided into compiler levels which may include various stages or components of the compiler. For example, a first compiler level may include the algebraic graph compiler including the MAC stage and the AIR stage, the second compiler level may include the ARC and the template library, and the third compiler level may include the PNR. In another example, the first compiler level may also include the dataflow graph compiler. The systems and techniques disclosed herein include examples in which failure handling data is selectively provided by one or more stages or components of the third compiler level to the stages or components of either the first compiler level or the second compiler level based on a determination of whether the failure is resolvable by the first compiler level or the second compiler level (e.g., which compiler level is preferred or most efficient at handling that failure type). Examples are not limited to three compiler levels nor are examples limited to failures occurring in the third compiler level. For example, the AIR stage or the template library may be separate from the first compiler level or second compiler level, respectively and operate as an additional compiler level which may be provided with error handling data for error handling or may provide error handling data for error handling by another compiler level.

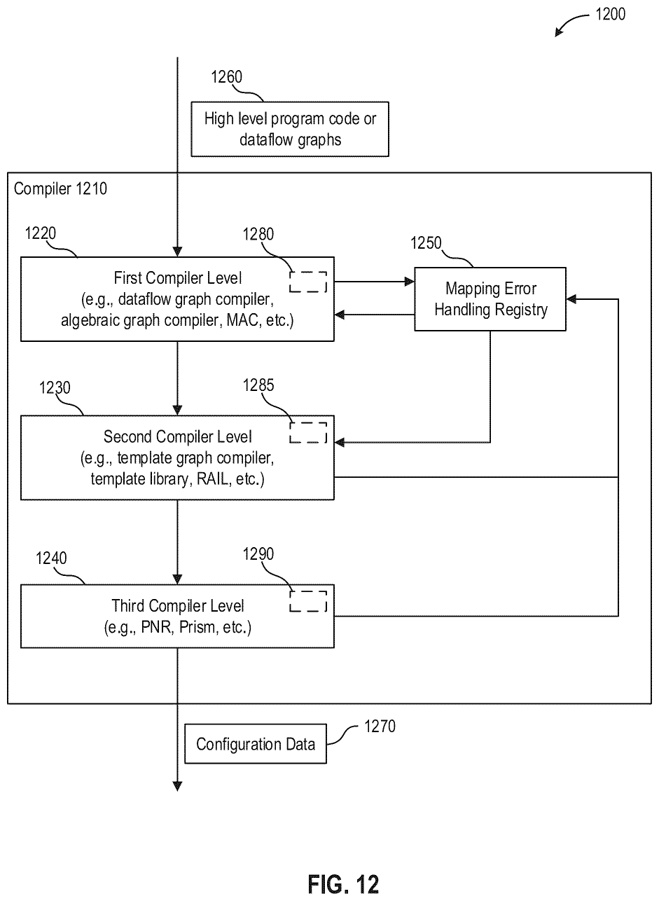

FIG. 12 shows a diagram 1200 of a compiler 1210 with dataflow for executing the compute graph compilation for a CGR dataflow computing system corresponding to the systems and techniques disclosed herein. As illustrated, the compiler 1210 may include a first compiler level 1220, a second compiler level 1230, a third compiler level 1240 and a mapping error handling registry 1250. More particularly, the diagram 1200 depicts the dataflow of the compilation process including selective iterative feedback from the third compiler level 1240 to different compiler levels (e.g., from the third compiler level 1240 to the first compiler level 1220 or the second compiler level 1230). The compiler 1210 may operate to receive high level program code or dataflow graphs as input data 1260 and output configuration data 1270 based thereon as discussed below.

In operation, the first compiler level 1220 may include one or more of a dataflow graph compiler, an algebraic graph compiler, a MAC, an AIR and so on. The first compiler level 1220 (e.g. the MAC) may perform mapping decisions based on input data 1260 (e.g., dataflow graphs based generated for a high-level program) in an initial pass but additionally or alternatively utilize information stored in the mapping error handling registry 1250 in subsequent passes. Further, the first compiler level 1220 may store various information in the mapping error handling registry 1250 such as the current graph and/or current compilation configuration for use subsequent passes.

Similarly, the second compiler level 1230 may include one or more of a template graph compiler, a template library, a RAIL, a TLIR and so on. The second compiler level 1230 may determine template library intermediate representation statements or graphs to be placed and routed by a PNR of the third compiler level 1240. For example, an ARC of the second compiler level 1230 may determine the TLIR statements or graphs based on input data from a MAC of the first compiler level 1220 and/or error handling data stored in the mapping error handling registry 1250 by one or more components of the compiler during previous passes. The second compiler level 1230 may also store various information in the mapping error handling registry 1250 for subsequent passes.

The third compiler level 1240 may include a PNR stage, a PRISM stage and so on. The third compiler level 1240 may generate the configuration files 1270 (e.g., processor-executable format (PEF) files) that, when executed by a CGR processor, perform the computing task of the high level program associated with the input data 1260 received by the first compiler level 1220. As discussed above, the third compiler level 1240 may store various information in the mapping error handling registry 1250 such as to allow for error handling by the first compiler level 1220 or the second compiler level 1230.

While shown as a single compiler 1210 and a single mapping error handling registry 1250, this is for ease of illustration and explanation. As discussed below, the compiler 1210 may operate in multiple processes or in multiple computing devices. For example, the first compiler level 1220 or the second compiler level 1230 may operate in a first process on a first computing device while the PNR is operating in a second process on the first computing device or on a second computing device. Further, the mapping error handling registry 1250 may include multiple storage locations or storage types which may differ between the first compiler level 1220, the second compiler level 1230, and the third compiler level 1240. For example, one or more of the first compiler level 1220, the second compiler level 1230, and/or the third compiler level 1240 may have corresponding instances or types of storage depending on the implementation details. Such additional or alterative storage locations are illustrated as mapping error handling registries 1280, 1285 and 1290.

In general, the mapping error handling data may be stored or conveyed in-memory or on-disk. In-memory storage may be faster and more robust, while serializing the mapping error handling data on-disk may be more easily implemented with distributed or multiple processes.

The mapping error handling data information can be serialized by many different protocols (e.g., protobuf, json, built-in serialization from MLIR, bson, etc.). Some protocols, such as protobuf, may have the benefit of having explicit protocol definition and can be switched between binary and human readable formats. Other protocols, such as Json, may have the benefit of being flexible.

While particular compiler levels are illustrated as having feedback mechanisms to the mapping error handling registry 1250, implementations are not limited to the illustrated examples. For example, other levels or modules may be included as additional compiler levels, (e.g., a compiler levels for the AIR stage) and may provide feedback for use by the MAC or the ARC of compiler levels 1220 or 1230. Further, while the first compiler level 1220, the second compiler level 1230, and the third compiler level 1240 are illustrated as being able to operate from feedback from the mapping error handling registry 1250, implementations are not so limited. For example, additional or alternative compiler levels may operate from mapping error handling data from the mapping error handling registry 1250. For example, the AIR stage of an additional compiler level may provide the transformed graph as feedback after spatial tiling for better mapping decisions by the MAC of the first compiler level.

In another example, the TLIR stage may operate as an additional compiler level and may pass back information about layout transforms and buffers inserted to aid the MAC of the first compiler level 1220 with section cutting decisions. For example, the mapping of two low latency operations, opA and opB, in the same stage may appear okay to the MAC of the first compiler level 1220 initially but be found to cause a latency bottleneck due to the TLIR inserting lots of layout transforms and buffers. The TLIR may provide mapping error handling data regarding the latency bottleneck to the MAC as feedback which may cause the MAC to change the stage boundary to separate opA and opB into different stages.

Depending on the example, the interface between the mapping error handling registry 1250 and the first compiler level 1220, the second compiler level 1230, and the third compiler level 1240 may vary.

For example, where two or more of the first compiler level 1220, the second compiler level 1230, and the third compiler level 1240 are within a same process, the mapping error handling registry 1250 may be the intermediate representation (IR) data of the passing compiler level and passed within the process directly.

Within a single compilation process, whenever lower compiler levels want to signal to the higher compiler levels that compilation has failed or may need to be adjusted, the lower compiler level may throw out errors (e.g., from a predefined list of mapping-related errors) and return the most recent IR as error handling data (e.g., along with any other information useful to the higher compiler level). For each mapping related error thrown, the higher compiler level may look up the corresponding error handling mechanism from a registry, adjust the mapping decisions made by the higher compiler level, and re-trigger compilation by the lower compiler level(s). Both the error throwing and the IR passing may happen in memory in the same process.

For errors that can trigger this feedback process, the higher compiler levels may maintain a portion of the registry 1250 that associates each type error with an error analysis mechanism. These error analyses may extract and provide relevant information from the IRs and feed the analysis results to the higher compiler level's mapping components to get adjusted mapping decisions. In some examples, error analyses may re-use existing analysis passes in the ARC and PNR.

When one or more of the first compiler level 1220, the second compiler level 1230, and the third compiler level 1240 is invoked in a separate process, processor or computing device, the mapping error handling registry may include cross-process communication mechanism(s) to convey the error handling information. Such cross-process communication mechanism(s) may include using files, pipes, sockets, and so on. For example, the IRs and analysis data of a lower compiler level may be stored to disk as on-disk files to convey the error information.

As will be appreciated by those of ordinary skill in the art, aspects of the various embodiments described herein may be embodied as a system, device, method, process, or computer program product apparatus. Accordingly, elements of the present disclosure may take the form of an entirely hardware embodiment, an entirely software embodiment (including firmware, resident software, micro-code, or the like) or an embodiment combining software and hardware aspects that may all generally be referred to herein as a “apparatus,” “circuit,” “circuitry,” “module,” “computer,” “logic,” “FPGA,” “unit,” “system,” or other terms. Furthermore, aspects of the various embodiments may take the form of a computer program product embodied in one or more computer-readable medium(s) having computer program code stored thereon. The phrases “computer program code” and “instructions” both explicitly include configuration information for a CGRA, an FPGA, or other programmable logic as well as traditional binary computer instructions, and the term “processor” explicitly includes logic in a CGRA, an FPGA, or other programmable logic configured by the configuration information in addition to a traditional processing core. Furthermore, “executed” instructions explicitly includes electronic circuitry of a CGRA, an FPGA, or other programmable logic performing the functions for which they are configured by configuration information loaded from a storage medium as well as serial or parallel execution of instructions by a traditional processing core.

Any combination of one or more computer-readable storage mediums may be utilized. A computer-readable storage medium may be embodied as, for example, an electronic, magnetic, optical, electromagnetic, infrared, or semiconductor system, apparatus, or device, or other like storage devices known to those of ordinary skill in the art, or any suitable combination of computer-readable storage mediums described herein. In the context of this document, a computer-readable storage medium may be any tangible medium that can contain, or store, a program and/or data for use by or in connection with an instruction execution system, apparatus, or device. Even if the data in the computer-readable storage medium requires action to maintain the storage of data, such as in a traditional semiconductor-based dynamic random-access memory, the data storage in a computer-readable storage medium can be considered to be non-transitory. A computer data transmission medium, such as a transmission line, a coaxial cable, a radio-frequency carrier, and the like, may also be able to store data, although any data storage in a data transmission medium can be said to be transitory storage. Nonetheless, a computer-readable storage medium, as the term is used herein, does not include a computer data transmission medium.

Computer program code for carrying out operations for aspects of various embodiments may be written in any combination of one or more programming languages, including object-oriented programming languages such as Java, Python, C++, or the like, conventional procedural programming languages, such as the “C” programming language or similar programming languages, or low-level computer languages, such as assembly language or microcode. In addition, the computer program code may be written in VHDL, Verilog, or another hardware description language to generate configuration instructions for an FPGA, CGRA IC, or other programmable logic. The computer program code if converted into an executable form and loaded onto a computer, FPGA, CGRA IC, or other programmable apparatus, produces a computer implemented method or process. The instructions which execute on the computer, FPGA, CGRA IC, or other programmable apparatus may provide the mechanism for implementing some or all of the functions/acts specified in the flowchart and/or block diagram block or blocks. In accordance with various implementations, the computer program code may execute entirely on the user's device, partly on the user's device and partly on a remote device, or entirely on the remote device, such as a cloud-based server. In the latter scenario, the remote device may be connected to the user's device through any type of network, including a local area network (LAN) or a wide area network (WAN), or the connection may be made to an external computer (for example, through the Internet using an Internet Service Provider). The computer program code stored in/on (i.e., embodied therewith) the non-transitory computer-readable medium produces an article of manufacture.

The computer program code, if executed by a processor, causes physical changes in the electronic devices of the processor which change the physical flow of electrons through the devices. This alters the connections between devices which changes the functionality of the circuit. For example, if two transistors in a processor are wired to perform a multiplexing operation under control of the computer program code, if a first computer instruction is executed, electrons from a first source flow through the first transistor to a destination, but if a different computer instruction is executed, electrons from the first source are blocked from reaching the destination, but electrons from a second source are allowed to flow through the second transistor to the destination. So, a processor programmed to perform a task is transformed from what the processor was before being programmed to perform that task, much like a physical plumbing system with different valves can be controlled to change the physical flow of a fluid.

What is claimed is:

1. A system comprising a compiler configured to conduct a method of transforming a high-level program of a computing task into configuration data executable by reconfigurable dataflow processor (RDP) including one or more arrays of configurable units, the compiler including at least a first compiler level of the compiler and a second compiler level of the compiler, the method comprising:
receiving, by the second compiler level, a first intermediate representation of the high-level program generated by the first compiler level or that is based on another intermediate representation generated by the first compiler level;
determining a failure occurred during a generating of a first representation of the high-level program by the second compiler level of the compiler, wherein the generating of the first representation is based on the first intermediate representation and the first representation of the high level program is one of a second intermediate representation of the high level program or the configuration data;
generating, by the second compiler level, error handling data for use by the first compiler level;
generating, by the first compiler level of the compiler and based on the error handling data, a third intermediate representation of the high-level program; and
generating, by the second compiler level of the compiler and based on one of the third intermediate representation or a fourth intermediate representation generated based on the third intermediate representation, a second representation of the high-level program, the second representation of the high level program being one of a fifth intermediate representation of the high level program or the configuration data.

2. The system of claim 1, wherein:
the first compiler level includes a template graph compiler stage; and
the second compiler level includes a place and route stage.

3. The system of claim 2, wherein:
the failure is associated with a template included in the first intermediate representation, where the template includes multiple configurable units to be placed and routed as a predefined group and that cannot be placed and routed as the predefined group by the second compiler level within a hardware capacity of the RDP; and
the generating, by the first compiler level of the compiler and based on the error handling data, the third intermediate representation of the high-level program allows for the placement and routing of the multiple configuration units of the template to vary from the predefined group of the template.

4. The system of claim 1, wherein:
the first compiler level includes an algebraic graph compiler; and
the second compiler level includes a place and route stage.

5. The system of claim 1, the method further comprising:
sectioning a dataflow graph of the high level program into a plurality of sections;
wherein:
at least the first compiler level and the second compiler level perform compilation operations on a per section basis based on the plurality of sections.

6. The system of claim 5, wherein:
the failure is associated with a number of configurable units to be placed and routed in a particular section of the plurality of sections by the second compiler level exceeding a hardware capacity for the section; and
the generating, by the first compiler level of the compiler and based on the error handling data, of the third intermediate representation of the high-level program adjusts a per section resource scaling factor of the particular section, wherein the per section resource scaling factor is used in mapping decisions for the particular section.

7. The system of claim 5, wherein:
the failure is associated at least a particular section of the plurality of sections;
the error handling data indicates sections of the plurality of sections which were successfully compiled before the failure of particular section; and
the generating of the third intermediate representation and second representation reuses the successfully compiled sections of the plurality of sections.

8. The system of claim 5, wherein:
the second representation of the high level program is the configuration data;
the configuration data, when loaded onto an instance of the array of configurable units, causes the array of configurable units to implement at least a section of the plurality of sections of the dataflow graph; and
the method further comprising:
storing the configuration data in a non-transitory computer-readable storage medium.

9. The system of claim 1, wherein:
the compiler further includes at least a third compiler level; and
the method further comprises:
determining, from among the first compiler level and the third compiler level, to return compilation operations to the first compiler level based on the failure and the error handling data.

10. A method of transforming a high-level program of a computing task into configuration data executable by a reconfigurable dataflow processor (RDP) including one or more arrays of configurable units, the compiler including at least a first compiler level of the compiler, a second compiler level of the compiler and a third compiler level of the compiler, the method comprising:
receiving, by the third compiler level, a first intermediate representation of the high-level program generated by the second compiler level, wherein the first intermediate representation is based on a second intermediate representation generated by the first compiler level;
determining a failure occurred during a generating of the configuration data of the high-level program by the third compiler level, wherein the generating of the configuration data is based on the first intermediate representation;
generating, by the third compiler level, error handling data for the failure for use by the first compiler level or the second compiler level;
determining, based on the failure and the error handling data, whether to return compilation operations to one of the first compiler level or the second compiler level; and
returning the compilation operations to the determined one of the first compiler level and the second compiler level.

11. The method of claim 10, wherein:
the first compiler level includes an algebraic graph compiler;
the second compiler level includes a template graph compiler; and
the third compiler level includes a place and route stage.

12. The method of claim 10, wherein the determined one of the first compiler level and the second compiler level is the first compiler level, the method further comprising:
generating, by the first compiler level of the compiler and based on the error handling data, a third intermediate representation of the high-level program;
generating, by the second compiler level of the compiler and based on third intermediate representation of the high-level program, a fourth intermediate representation of the high level program; and
generating, by the third compiler level of the compiler and based on the fourth intermediate representation, the configuration data of the high-level program.

13. The method of claim 12, the method further comprising:
sectioning a dataflow graph of the high level program into a plurality of sections,
wherein the first compiler level, the second compiler level, and the third compiler level perform compilation operations on a per section basis based on the plurality of sections.

14. The method of claim 13, wherein:
the failure is associated with a number of configurable units to be placed and routed in a particular section by the third compiler level exceeding a hardware capacity for the section; and
the generating, by the first compiler level of the compiler and based on the error handling data, the third intermediate representation of the high-level program adjusts a per section resource scaling factor of the particular section used in mapping decisions for the particular section based on the error handling data.

15. The method of claim 13, wherein:
the failure is associated at least a particular section of the plurality of sections;
the error handling data indicates sections of the plurality of sections which were successfully compiled before the failure of particular section; and
the generating of the third intermediate representation and fifth intermediate representation reuses the successfully compiled sections of the plurality of sections.

16. The method of claim 10, wherein the determined one of the first compiler level and the second compiler level is the second compiler level, the method further comprising:
generating, by the second compiler level of the compiler and based on the error handling data, a third intermediate representation of the high-level program;
generating, by the third compiler level of the compiler and based on the third intermediate representation, the configuration data of the high-level program.

17. A computer program product comprising a computer readable storage medium having program instructions embodied therewith, wherein the computer readable storage medium is not a transitory signal per se, wherein the program instructions are executable by a processor to cause the processor to conduct a method of transforming a high-level program of a computing task into configuration data executable by a reconfigurable dataflow processor (RDP) including one or more arrays of configurable units, the compiler including at least a first compiler level of the compiler and a second compiler level of the compiler, the method comprising:
receiving, by the second compiler level, a first intermediate representation of the high-level program generated by the first compiler level or that is based on another intermediate representation generated by the first compiler level;
determining a failure occurred during a generating of a first representation of the high-level program by the second compiler level of the compiler, wherein the generating of the first representation is based on the first intermediate representation and the first representation of the high level program is one of a second intermediate representation of the high level program or the configuration data;
generating, by the second compiler level, error handling data for use by the first compiler level;
generating, by the first compiler level of the compiler and based on the error handling data, a third intermediate representation of the high-level program; and
generating, by the second compiler level of the compiler and based on one of the third intermediate representation or a fourth intermediate representation generated based on the third intermediate representation, a second representation of the high-level program, the second representation of the high level program being one of a fifth intermediate representation of the high level program or the configuration data.

18. The computer program product of claim 17, wherein:
the first compiler level includes a template graph compiler level;
the second compiler level includes a place and route level.
the failure is associated with a template included in the first intermediate representation, where the template includes multiple configurable units to be placed and routed as a predefined group and that cannot be placed and routed as the predefined group by the second compiler level within a hardware capacity of the RDP; and
the generating, by the first compiler level of the compiler and based on the error handling data, the third intermediate representation of the high-level program allows for the placement and routing of the multiple configuration units of the template to vary from the predefined group of the template.

19. The computer program product of claim 17, the method further comprising:
sectioning a dataflow graph of the high level program into a plurality of sections;
wherein:
the first compiler level includes an algebraic graph compiler level;
the second compiler level includes a place and route level;
at least the first compiler level and the second compiler level perform compilation operations on a per section basis based on the plurality of sections;
the failure is associated with a number of configurable units to be placed and routed in a particular section by the second compiler level exceeding a hardware capacity for the section; and
the generating, by the first compiler level of the compiler and based on the error handling data, the third intermediate representation of the high-level program adjusts a per section resource scaling factor of the particular section that is used in mapping decisions for the particular section.

20. The computer program product of claim 17, the method further comprising:
sectioning a dataflow graph of the high level program into a plurality of sections;
wherein:
the failure is associated at least a particular section of the plurality of sections;
the error handling data indicates sections of the plurality of sections which were successfully compiled before the failure of particular section; and
the generating of the third intermediate representation and the second representation reuses the successfully compiled sections of the plurality of sections.
